(19) United States
(12) Patent Application Publication
(10) Pub. No.: US 2020/0063479 A1
(43) Pub. Date: Feb. 27, 2020

(54) Adjustable Door Hinge

(71) Applicant: Nickolas Klassen, Sherwood Park (CA)

(72) Inventor: Nickolas Klassen, Sherwood Park (CA)

(21) Appl. No.: 16/521,783

(22) Filed: Jul. 25, 2019

Related U.S. Application Data
(60) Provisional application No. 62/722,274, filed on Aug. 24, 2018.

(51) Int. Cl. E05D 7/00; E05D 3/02; E05D 5/14

(52) U.S. Cl. CPC E05D 7/0054; E05D 3/02; E05D 2007/0072; E05Y 2900/132; E05D 5/14

(57) ABSTRACT

An adjustable door hinge is described. The adjustable door hinge includes a bottom plate and a top plate. Each plate has a at least one barrel attached to one side of each of the plates. The barrels have a hole placed through such that the barrels can accept a pin. A pin is placed through the barrels such that the bottom plate and top plate are rotatably connected together. The pin allows the adjustable door hinge to rotate and align a door in a doorjamb. A set screw is attached to a barrel such that the pin is held in the correct position and the hinges stay properly aligned.

### CROSS REFERENCE TO RELATED APPLICATIONS

This application claims the benefit of U.S. Provisional Application No. 62/722,274 filed on Aug. 24, 2018. The above identified patent application is herein incorporated by reference in its entirety to provide continuity of disclosure.

### BACKGROUND OF THE INVENTION

The present invention relates to an adjustable door hinge. More particularly, the present invention provides an adjustable door hinge that allows the hinge barrels to be offset such that the door will be aligned in a door jamb.

Installing and adjusting doors and door hinges can be a difficult and frustrating process. The door can bind in a jamb and lead to damage to a wall surface or a door jamb. The door slab may need sanding or cutting, and contractors/homeowners may have to completely remove the door, risking damage to the door and surrounding areas. In order to address these concerns, the present invention provides an adjustable door hinge that can be adjusted to allow a user to easily and efficiently perform various adjustments or complete other tasks on the door.

Consequently, there is a need in for an improvement in the art of door hinges. The present invention substantially diverges in design elements from the known art while at the same time solves a problem many people face in aligning doors after a structure shifts or settles. In this regard the present invention substantially fulfills these needs.

### SUMMARY OF THE INVENTION

The present invention provides an adjustable door hinge wherein the same can be utilized for providing convenience for the hen adjusting a door in a door jamb. The present system comprises an adjustable door hinge which includes a bottom plate and a bottom plate. Each plate has a at least one barrel attached to one side of each of the plates. The top barrel has a hole placed through and the bottom plate has a pin such that the barrels can accept a shaft. A pin placed through the barrels such that the bottom plate and top plate are rotatably connected together. The shaft has an offset hole and is configured such that the hinge can be rotated there about and align a door in a doorjamb. A set screw is attached to a barrel such that the shaft is held in the correct position as the hinges move during door operation.

Another object of the invention is to provide an adjustable door hinge comprising a bottom plate having a first barrel attached to one side of the plate, wherein the top barrel has a hole therethrough. A bottom plate having a pin attached to one side of the plate. A pin that is attached to the bottom plate is configured to be received by the top barrel, such that the bottom plate and top plate are rotatably connected together thereby. Another shaft having an offset hole located therein. The shaft is configured to be received by the top barrel and receive the bottom pin in the offset hollow portion. The shaft is configured such that it can be rotated and align a door in a doorjamb, wherein the shaft has a head on a top side that is configured to accept an alien key. A set screw is located in the side of the top plate to hold the shaft in the correct location once the door jamb is aligned.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the adjustable door hinge.

FIG. 2 shows an exploded view of the adjustable door hinge.

FIG. 3 shows a perspective view of an embodiment of the shaft for the adjustable door hinge.

FIG. 4 shows a cross sectional view of an embodiment of the adjustable door hinge.

FIG. 5 shows a perspective view of an embodiment of the adjustable door hinge being adjusted by the shaft.

### DETAILED DESCRIPTION OF THE INVENTION

Reference is made herein to the attached drawings. Like reference numerals are used throughout the drawings to depict like or similar elements of the adjustable door hinge. For the purposes of presenting a brief and clear description of the present invention, the preferred embodiment will be discussed as used for the adjustable door hinge. The figures are intended for representative purposes only and should not be considered to be limiting in any respect.

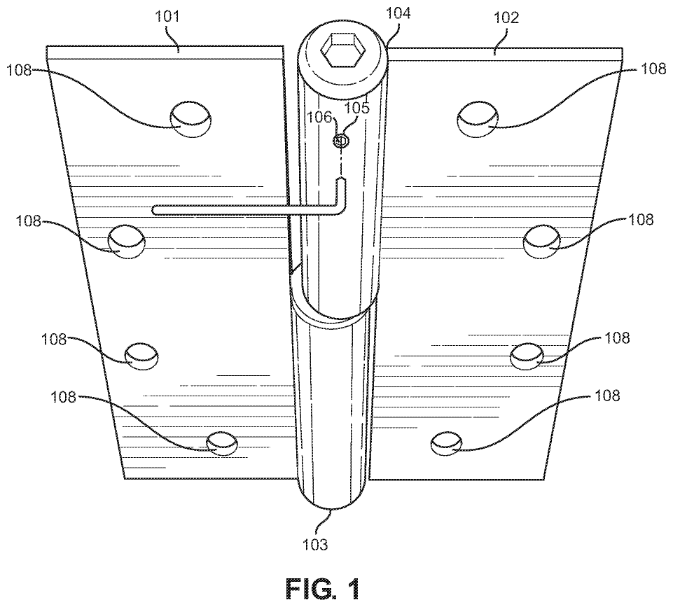

Referring now to FIG. 1, there is shown a perspective view of an embodiment of the adjustable door hinge. The adjustable door hinge includes a bottom plate 101 and a top plate 102. In one embodiment, the bottom plate 101 and the top plate 102 have a plurality of apertures 108 located therethrough which will accept screws to attach the hinge to a door and doorjamb. The bottom plate 101 has a bottom barrel 103 attached to a side of the bottom plate 101. The top plate 102 has a top barrel 104 attached to a side of the top plate 102. The barrels 103, 104 may be configured such that the top barrel 104 sits on top of the bottom barrel 103. The bottom barrel 103 and the top barrel 104 are round. In one embodiment the bottom barrel 103 has a pin and the top barrel 104 have a hole located therethrough. The top barrel 104 has a treaded hole 105 located on the side of the barrel and goes therethrough on side of the top barrel. This hole is configured to accept a set screw 106.

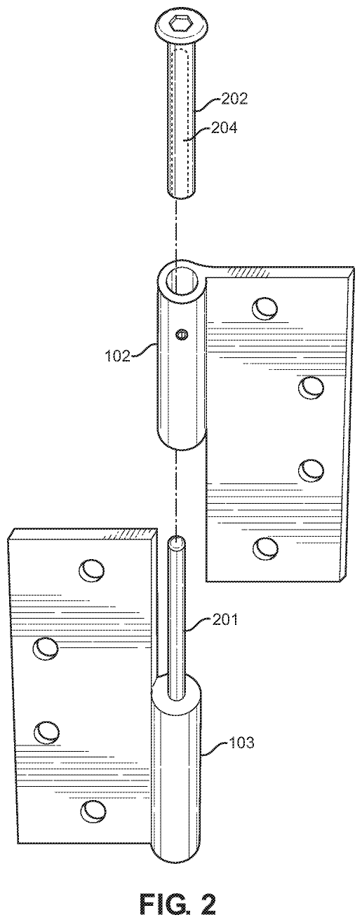

Referring now to FIG. 2, there is shown an exploded view of the adjustable door hinge. The bottom part of the hinge has a pin 201 attached to the bottom barrel 103. In one embodiment, the pin 201 is attached to the bottom barrel 103. A shaft 202 is configured to be received by the top barrel 104.

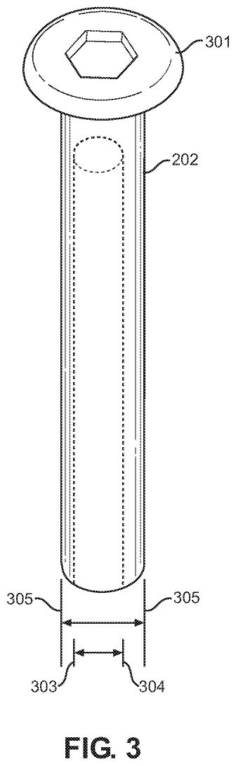

Referring now to FIG. 3, there is shown a perspective view of an embodiment of the shaft for the adjustable door hinge. The shaft 202 has a hollow interior portion 204. This hollow interior portion is off-center. In this configuration a first edge 303 of the hollow interior portion 204 is closer to the outer edge 305 of the shaft 202. A second edge 304 if the hollow interior portion 204 is further from the outer edge 305 of the shaft 202. The hollow interior portion 204 is configured to accept the first pin 201 therein, thereby rotatably securing the bottom plate to the top plate. The shaft 202 has a top portion 301 configured to accept an adjusting tool. This top portion 301 may be configured to accept Allen wrenches. In a second embodiment, the top portion 301 may be configured to accept screw drivers. The shaft 202 is configured to be held in place when the set screw has been tightened.

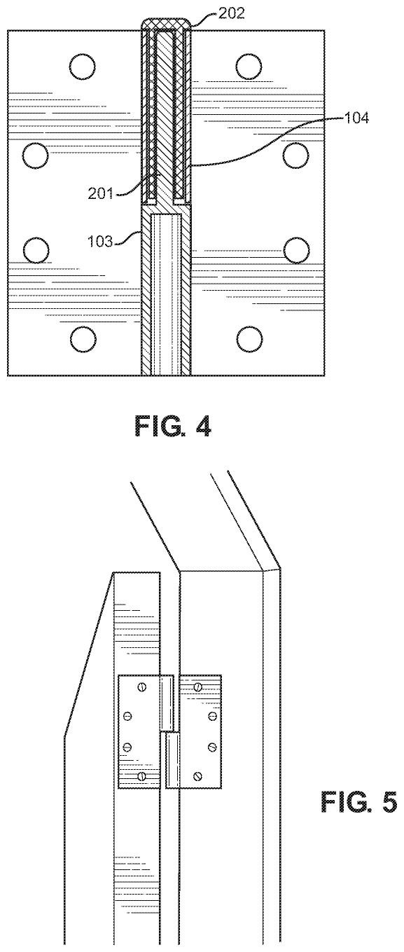

Referring now to FIG. 4, there is shown a cross sectional view of an embodiment of the adjustable door hinge. In the shown embodiment, the bottom barrel 103 has the first pin 201 permanently attached. In this embodiment the first barrel is solid and has no hollow portion. The first pin 201 is a construct of the first barrel and extends upwardly therefrom.

The top barrel 104 having the hollow center going all the way therethrough. The top barrel 104 is proportioned to receive the shaft 202 therethrough. This reception is a rotatable connection. This means that the shaft 202 will be able to rotate when placed within the top barrel 104. Once the shaft 202 is placed within the hollow portion of the top barrel 104 the bottom pin 201 can be placed with in the shaft 202. The bottom pin 201 will be rotatably received by the shaft 202. This allows the hinge to rotate around the first pin 201.

Once the bottom pin 201 and shaft 202 are placed together the shaft 202 can be rotated within the top barrel 104 and around the bottom pin 201. This will allow the hinge to offset as shown in FIG. S. Using this adjustment the hinge can be used to angle the door to ensure a proper fit within the door way.

Referring now to FIG. 5, there is shown a perspective view of an embodiment of the adjustable door hinge being adjusted by the second pin. The adjustable door hinge may be adjusted such that it is off-center and the door will properly fit in the door jamb. By rotating the second pin the door will be adjusted. Once the shaft 202 has been rotated into the proper place the set screw can then be tightened. This will hold the shaft 202 in place keeping the hinge in the adjusted state.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) An adjustable door hinge comprising:
a bottom plate having a bottom barrel attached to one side of the bottom plate, wherein the bottom barrel further comprises a hole therethrough;
a top plate having a top barrel attached to one side of the top plate;
a bottom pin configured to be received by the bottom barrel, wherein the bottom plate and top plate are rotatably connected together;
a shaft having an offset hollow portion located therein;
wherein the shaft is configured to be received by the top barrel and receive the bottom pin in the offset hollow portion; and
wherein the shaft is configured such that it can be rotated and align a door in a doorjamb.

2) The adjustable door hinge of claim 1, further comprising a set screw in the top barrel o hold the shaft in a desired location.

3) The adjustable door hinge of claim 1, wherein the shaft further comprises a head on a top side thereof, the head configured to accept an alien key.

4) The adjustable door hinge of claim 1, wherein the shaft further comprises a head on a top side thereof, the head configured to accept a screw driver.

5) The adjustable door hinge of claim 1, wherein the first pin is attached to the bottom barrel.

6) The adjustable door hinge of claim 1, wherein the bottom barrel further comprises a hollow center and the first pin is situated therein.

7) The adjustable door hinge of claim 1, wherein the bottom plate and the top plate have a plurality of apertures located therethrough, to allow for a screws to be placed therein securing the hinge to a door frame and a door.

8) An adjustable door hinge comprising:
a bottom plate having a bottom barrel attached to one side of the bottom plate, wherein the bottom barrel further comprises a hole therethrough;
a top plate having a top barrel attached to one side of the top plate;
a bottom pin configured to be received by the bottom barrel, wherein the bottom plate and top plate are rotatably connected together;
a shaft having an offset hollow portion located therein;
the shaft is configured to be received by the top barrel and receive the bottom pin in the offset hollow portion;
the shaft is configured such that it can be rotated and align a door in a door jamb, wherein the shaft has a head on a top side that is configured to accept an alien key;
a set screw in the second barrel to hold the shaft in the correct location once the do b is aligned.

9) The adjustable door hinge of claim 8, wherein the bottom pin in attached to the bottom barrel.

10) The adjustable door hinge of claim 8, wherein the bottom barrel has a hollow center and the bottom pin is situated therein.

11) The adjustable door hinge of claim 8, wherein the bottom plate and the top plate have a plurality of apertures located therethrough, to allow for a screw to be placed therein securing the hinge to a door frame and a door.
